(19) United States
(12) Patent Application Publication
(10) Pub. No.: US 2008/0248164 A1
(43) Pub. Date: Oct. 9, 2008

(54) Supply Component for Liquids and Gases

(75) Inventor: Pasquale Spiegel, Glinde (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: MARGRET SPIEGEL, 21509 GLINDE (DE)

(21) Appl. No.: 11/912,579

(22) PCT Filed: Apr. 21, 2006
(86) PCT No.: PCT/DE2006/000715

§ 371 Date: Jun. 9, 2008

(30) Foreign Application Priority Data
Apr. 25, 2005 (DE) 10 2005 019 410.9

(51) Int. Cl. B01F 3/04; B01F 5/06

(52) U.S. Cl. 426/67; 261/78.2; 261/127; 261/152; 261/34.1; 261/69.1

(57) ABSTRACT

The invention relates to a filled or unfilled supply component for gases or fluids, which is not required in order to carbonate, preferably, an upstream and downstream carbonator and which is, preferably, used therefore, preferably in at least one booster pump which allows a carbonated liquid to flow through, and, can preferably be withdrawn over at least one dispensing location.

The invention shows: at least one supply component filled with preferably bulk material for liquids and gases which is used for carbonation.

State-of-the-art is, for example, that liquids and gases are supplied to a, for example, carbonating vessel for carbonation. These are introduced in the carbonating vessel through two separate lines. In this case, a supply component is not used for simultaneously supplying gases and liquids into the carbonating vessel which is preferably used for carbonating. In the state-of-the-art, by inventions by Mrs. Margaret Spiegel, the following patent-application Serial No. 100 55 137.8 “Supply Component For Gas And Liquids” discloses a so-called supply component for gases and liquids, and proposes with reference to at least one mixer for gases and liquids or carbonator system, to also employ a supply component for liquids and, preferably, CO₂. This is generally done by flowing liquids and gases in the supply component towards an inline-carbonator, and can therefore only viewed as state-of-the-art for an individual component of an inline-carbonator.

The entire application and description texts and claims do not suggest that the so-called component or components in the aforementioned applications, the so-called supply component can be used also simultaneously as an inline-carbonator for liquids and gases or pre-carbonator without a separate inline-carbonator, or that the aforementioned supply components are preferably filled with bulk material, secured by preferably sieve material.

It is also not suggested that the fill of the inline carbonator(s) or mixer(s), through the preferably tap water flows in a flow-through principle, is misted or nebulized by the fill for absorbing the preferably CO₂ and to combine therewith, and through this principle a large surface is produced and carbonation, for example, is performed. This is preferably solved by the invention of a component for liquids and gases, which is preferably filled with for example bulk material, as described below.

By already filling the supply component with preferably bulk material. By this measure, the supply component alone can already be used for carbonation and pre-carbonation, for example, preferably also without bulk material fill and without preferably retainer sieves. By preferably introducing tap water and preferably CO₂ into the aforementioned supply component.

In this process, the introduced liquid is directly incident on the introduced preferably CO₂, or the introduced liquids is incident on the bulk material inside the supply component for liquids and gases.

As a result, the liquid is for example separated or more clearly expressed nebulized by the large surface produced by the for example bulk material or the large surface of the interior wall of the supply component. When the preferably nebulized liquid flows towards preferably at least one post-mix valve or dispensing location, then the preferably nebulized liquid can combine with preferably CO₂ because at the same time preferably CO₂ as well as the liquid is introduced into the supply component. By this measure, the CO₂ can preferably mix with the nebulized liquid already in the supply component. This is viewed in the flow-through process as flow-through carbonation and is not used in stationary liquid carbonation processes, like, for example, in the carbonating vessel.

Or like the principle of inline-carbonators, where the carbonation process is performed only in the separate inline-carbonator. However, this takes place also in the flow-through carbonation process. This shows that the component, which is preferably filled with bulk material and used in the supply component for liquids and gases, which is preferably used for carbonation, is in itself inventive. Because with the invention, for example the carbonation vessel or the inline-carbonators are completely eliminated. Because the preferred liquid and gas introduction and the carbonation process take place in a single component.

Because injection molded components made of suitable plastic material can be used with the invention, cost-effective production can be easily implemented or existing components can be modified very inexpensively, for example pluggable connectors from the company John Guest, such as for example the T-connector from this company. These T-connectors can be modified so that they can be easily used, for example, without bulk material or filled with bulk material, as well as also provided with a sieve retainer material, such as for example hat sieves from the company Neoperl, for securing the solid maternal.

The off-the-shelf parts from the company John Guest can also be used to connect to the supply component, for example, tap water and gases via at least one screw connection.

The supply component can also be only partially filled with preferably bulk material, because the water flow presses the partially introduced bulk material against the retaining sieve, with the carbonated liquid flowing towards the outlet to at least one dispensing location, which is designed with at least one pump, which can preferably boost the pressure towards the dispensing location and is preferably designed as self-priming displacement pump or membrane pump.

The quantity of the flowing gas and liquid can depend on the size of the supply component for gases and liquids, preferably unfilled or filled with bulk material, depending on the respective through openings. This should preferably be taken into account when using at least one pump. The supply component for liquids and gases can also have a straight configuration with at least one inlet and outlet. This component can also be fabricated and applied as a Y-piece, for example for supplying carbonated liquid to two separate lines (not illustrated).

The employed backflow preventers (not illustrated) can preferably be secured by inserted lines.

The preferably retainer and impregnation sieves or sieve material can be arranged in any position inside or outside the supply component.

These advantages of the invention of at least one supply component, preferably carbonator, unfilled or filled with preferably bulk material, is not state-of-the-art according to our extensive searches and is therefore inventive in itself.

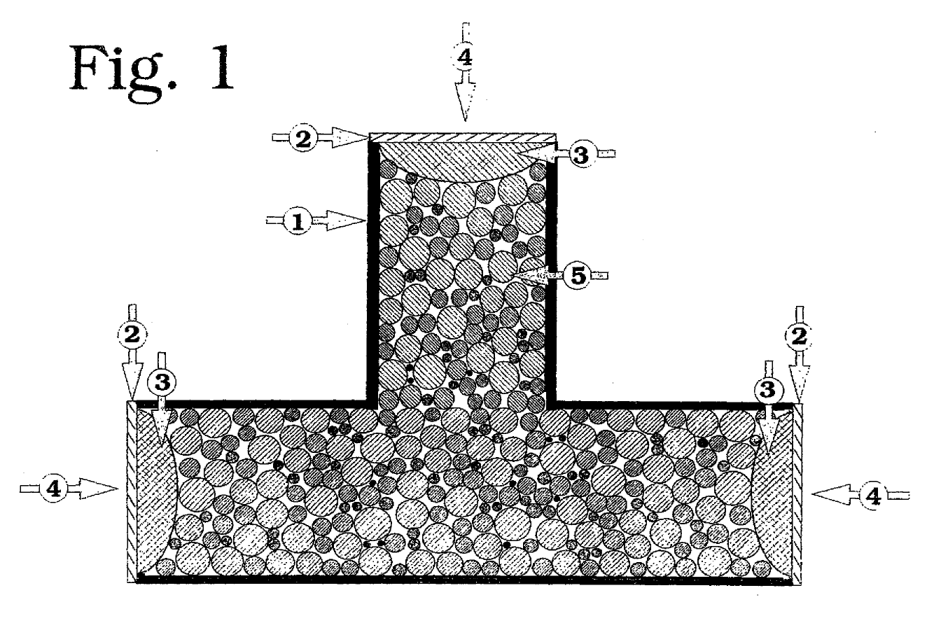

The following is an exact description of the invention, with the FIGS. 1-7 described and schematically illustrated:

The invention describes: supply components (1) (11) (12) unfilled or filled with preferably bulk material (5) for liquids and gases, which is preferably used for carbonating or impregnating without a separate carbonator principle or inline-carbonator principle as a separate component.

The invention preferably uses the component (1) which is preferably implemented as a hollow T-member (1). For filling this component (1) preferably with bulk material (5). Before this is done, retainer sieves (3) are preferably applied on, for example, two sides of the openings (4), which are in turn attached to the component (1) with gas-tight connections (not illustrated), in order to retain the sieves (3) and to enable supply of liquids and gases or to preferably function as an outlet for carbonated liquid. The retained sieves (3) are used to prevent the preferred bulk material (5) from being flushed out if, for example, liquid is introduced into the component (1) and preferably carbonated liquid is withdrawn. The sieves (3) are retained so that they do not uncontrollably slide into the component (1), by designing the sealing and retaining ring (2) so that it preferably rests on the material wall (1) and is in turn held in place, for example, by the sieve retainer (7) which is gas-tight. For example, the side on the component (1) which has not yet been secured with the retaining sieve (3) for preferably bulk material (5) is now used to fill in the preferably bulk material (5). This can be done, for example, either by pouring or for example also by suction (not illustrated).

After having been filled with preferably bulk material (5), the introduced bulk material (5) is also secured by the bulk material retainer sieve (3), and is also secured by the, for example, component (7). The process steps and use of material necessitate, for example, additional operating steps, for example attaching the component (13), which is preferably a gas-tight pluggable connector (14) for the nozzle for preferably the CO₂ introduction into the component (1), which is preferably filled with bulk material (5).

The component (13) is constructed so that a backfill preventer is inserted in the chamber (16) which seals gas-tight against the walls (14) and opens the gas or liquid flow in the direction (17) (not illustrated). The opening (17) is sized so that not too much or too little preferably CO₂ can enter the supply component (1) or (11) (12), so as to ensure continuous carbonation inside the component (1) (11) (12). To supply the preferred component (13) with preferably CO₂ (not illustrated), preferably the principle of the pluggable connector from the company John Guest for gases and liquids is applied, as seen in FIGS. (6) and (4). This has the advantage that mass-produced and proven components are used (not all embodiments are illustrated). Combinations of pluggable connections (8) (9) (7) and gas-tight screw connectors are also used (not illustrated). Preferably, the preferably stepped gas-tight peg (14) of the component (13) with the opening (17) is preferably inserted into the opening (4) of the component (12) and can be rendered gas-tight by way of the component (8) which is implemented as an elastic O-ring. The component (9), here implemented as a mounting element, ensures stable seating of the component (13) and prevents unintentional detachment, and can be adapted to any dimension (only partially illustrated).

The retaining element (9) is secured as an additional safety measure by a so-called retainer ring (not illustrated). Optionally, at least one component (13) can be attached gas-tight at each opening (4), which can be used for liquid and gas supply. The backflow preventers (at least 1) in the chamber (16) are used to prevent, for example, CO₂ from flowing into the main supply of preferably tap water, or the preferred second backflow preventer prevents, for example, tap water from entering the gas supply (not illustrated), as shown for example in FIG. 1: preferably, at least one gas supply and at least one liquid supply, without a predefined pattern, can be attached at the openings (4). At least one of the openings (4) should be unobstructed for withdrawing, for example, carbonated liquid via at least one dispensing location.

The invention has the advantage that the preferably tap water is directly incident on the preferred bulk material (5) when entering the opening (4), in combination with preferably CO₂, which can also enter at the same time through the opening (4) into the hollow body of the component (1) (11) (12). The flow of both media can be enabled in the direction of the dispensing location preferably by opening at least one dispensing location (not shown on the figures). Because the upstream backflow preventers open (not illustrated), which are inserted in the component 13) and these components (13) were attached gas-tight on the components (1) (11) (12). Consequently, the liquid and the gas enter the hollow body (1) (11) (12) via the openings (4). The liquid is nebulized or misted by the preferred supplied bulk material (5), so that the preferred

The gas flow for the preferably components (1) (11) (12) should preferably be occur through a pressure control valve, which is known from the invention and patent application by Mrs. Margaret Spiegel having the Application No.: 10055137.8 “Supply component for gases and liquids”, as well as from the German patent application of Aug. 11, 1998 with the Application No.: DEA 19851360 “Novel Mixer” because with this known invention the following is provided (not illustrated). If the supply components (1) (11) (12) are to be connected directly to the water mains, preferably city water, then pressure fluctuations can or occur in the supply component (1) (11) (12). If this occurs during carbonation, for example at least one dispensing operation, then a malfunction occurs during carbonation via the components (1) (11) (12), because constant carbonation is no longer possible due to a decrease, for example, in the water supply pressure, since a large quantity of liquid is withdrawn in the same building, resulting in an oversupply of gas inside the supply component (1) (11) (12), because the preset gas pressure must always be constant in relation to the respective liquid pressure, for example: 4 bar liquid pressure and 4 bar for example CO₂ pressure, because the liquid pressure drops during the dispensing operation, for example to 3.5 bar. This also depends of the dispensing locations, the greater the dispensed quantity of carbonated liquid, the greater the pressure drop in the supply component (1) (11) (12). The liquid pressure can be kept constant below an upper limit by a pressure regulator or a limiter, and the gas pressure also by at least one pressure regulator, preferably for CO₂. If the liquid pressure or the rest pressure of the liquid main supply occurs during carbonating, then the required liquid pressure can decrease, for example, from 3.5 bar to, for example, 2.8 bar. If the difference pressure of the fixed, preferably CO₂, pressure is too high, then the existing liquid is displaced within the supply component (1) (11) (12), and carbonation can no longer take place as a result. The reason therefore is that the, for example, CO₂ pressure does not significantly decrease even during the dispensing operation, as long as the gas reservoir and its pressure are applied, because for example a difference pressure of 0.5 bar with respect to the full pressure of the liquid is sufficient to ensure good continuous carbonation. This is an ensured because a certain pressure drop occurs during dispensing, but not in the gas flow. If during dispensing for example the pressure difference from the liquid flow decreases to for example 1.5 bar, then a massive malfunction occurs within the entire system during carbonation, up to the dispensing locations (not illustrated). All this can be prevented by a pressure regulator which is also employed in the context of the components (1) (11) (12) (not illustrated). The pressure regulator valve for liquids and gases operates according to the principle that the gas pressure above the actual liquid pressure, in the rest and flow pressure of the liquid depending on the main supply of the liquid or liquid reservoir, guarantees a constant difference pressure to the preferably CO₂ pressure, assuming that the gas control valve is connected with at least one gas reservoir (not illustrated).

The advantage is here that the component (1) (11) (12) controllably transfers the required preferably CO₂ pressure, even if the pressure of the liquids increases, to the CO₂ outlet location, which is connected with the component (1) (11) (12) via a line (not illustrated). This can be attained within the body of the pressure control valve for liquids and gases with a membrane or a piston separating the chambers for liquids and gases (not illustrated).

If the volume flow of the pressure control valve flowing through the regulator is insufficient, because the flow quantity is not sufficient, which also cannot be attained with the regulator to which a high liquid pressure is applied, then a bypass can be provided and the regulator does not supply the major portion of the liquid supply to at least one supply component (1) (11) (12), but is only used to measure the liquid pressure and to transfer the existing pressure controllably to the set gas pressure, thus providing good carbonation matched to the gas pressure and gas flow in the direction of the supply module (1) (11) (12) liquids and gases (not illustrated).

The described pressure control valve (not illustrated) also operates as a preventive measure if, for example, following the carbonation process, at least one preferably displacement pump is used to, for example, maintain carbonated liquid in a recirculating flow loop and is used as add-on cooling for beverage additives (not illustrated) in a post-mix process (not illustrated).

It may happen, if the afore-described control valve for liquids and gases is not used, that for example a CO₂ bubble remains in form of a deposit inside the pump, causing damage to the pump (not illustrated).

It is also a preventative measure if the for example CO₂ flow is only enabled during the dispensing operation (not illustrated).

In a preferred application for a supply component (1) (11) (12),

preferably filled with bulk material (5), for gases and liquids, which is designed as supply carbonator (1) (11) (12), the inline-pre-carbonator (1) (11) (12) is configured as at least one component for preferably carbonating tap water with CO₂.

According to preferred arrangements and components, at least one pressure controller for liquids (not illustrated) is supplied from at least one main liquid supply, as well as at least one pressure control valve which regulates the gas pressure via the liquid pressure and supplies this pressure control valve with liquid via the pressure controller for liquids (not illustrated).

Which supplies through at least one pressure control valve, which controls the gas pressure via the fluid pressure, at least one supply component (1) (11) (12) controllably with liquid and gases (not illustrated).

That the pressure control valve is connected with at least one gas reservoir, via lines or a direct connection to at least one gas reservoir container (not illustrated).

That the liquid, the supply component (1) (11) (12) can be pre-cooled before entering via the openings (4) (not illustrated).

That the preferably tap water which is preferably pre-carbonated or carbonated via the supply component (1) (11) (12) is introduced into a post-cool line to the preferably displacement pump for withdrawing the carbonated liquid preferably in at least one closed loop system, connected to for optional withdrawal of the carbonated liquid via at least one dispensing location (not illustrated). That the gas or liquid flow can be turned off before entering or after entering into the component (1) (11) (12), and can be opened via an electric valve connection or pressure drop switch so as to prevent a potentially undesirable incursion of gas into the supply component (1) (11) (12) if dispensing or carbonation does not takes place (not illustrated).

The supply component (1) (11) (12) is also used as an impulse carbonator with or without pump support (not illustrated).

FIG. 1 shows: supply component (1) (11) (12) filled with preferably bulk material (5), carbonator for gases and liquids with at least one sieve (3) retainer (2) and filled with a preferably polycarbonate granulate bulk material fill (5) with three inlet possibilities (4) for gases and liquids or with three selectable outlet possibilities (4) for preferably carbonated liquids. The surface of the component (1) (11) (12) is machined so that a gas-tight connection is possible by employing, for example, pluggable connectors from the company John Guest. The component (1) (11) (12) can also be provided with gas-tight or standard commercially available or specially manufactured thread, such as thread on the exterior and interior wall (not illustrated). Filled with preferably bulk material (5), the supply component (1) (11) (12) used with liquids and gases for carbonation or pre-impregnation, without a separate carbonator or inline-carbonator principle as a separate component (not illustrated), can also be designed, for example, as a Y-component (not illustrated) for advantageously supplying two carbonator recirculating loops with carbonated liquid (not illustrated). This is reliably implemented in that liquids and gases can flow into at least one opening (4) in the Y-component, filled with preferably bulk material (5) and secured by a retainer sieve (3), and in that the liquid and the gas are carbonated via the bulk material (5) due to the large surface area of the bulk material (5). The preferably carbonated liquid can flow into at least two separate preferably closed recirculating pumps through the at least two unused outlets (4) of the Y-component (not illustrated), or is suctioned in, and the carbonated liquid is supplied into recirculating lines at higher pressure into two separate flow loops by increasing the pressure with at least one pump (not illustrated). At least one Y-component can be connected with the openings (4), preferably via pluggable lines, in order to distribute the carbonated liquid, which is withdrawn from the components (1) (11) (12), without the need to fill the preferably employed Y-component with preferably bulk material (5) (not illustrated).

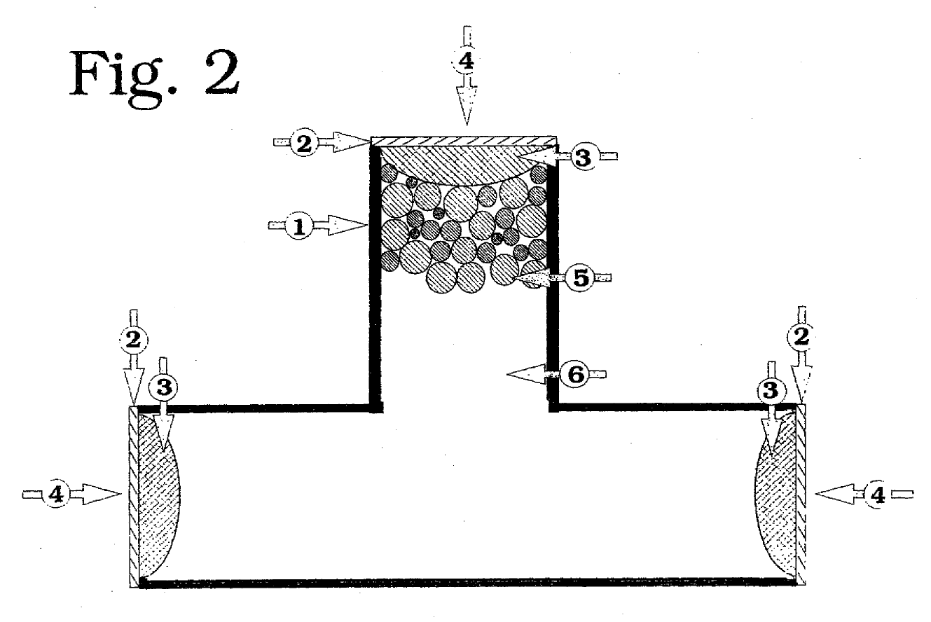

FIG. 2 shows: a supply component (1) only partially filled with preferably bulk material (5), carbonator for gases and liquids with at least one sieve (3) retainer (2) and only partially filled with preferably polycarbonate granulate bulk material (5) fill, having the same characteristic features as those shown in FIG. 1 and with application as a main use for carbonation.

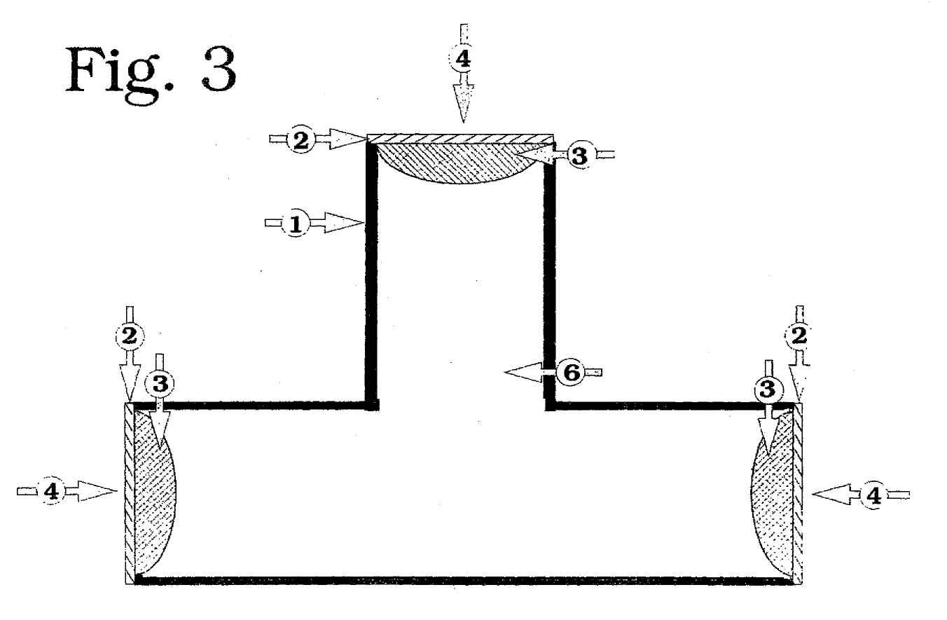

FIG. 3 shows: an unfilled supply component (1) which is not filled with preferably bulk material (5), but preferably has only at least three sieves (3) which are provided with a sieve retainer (2). In this application, the sieves (3) perform carbonating without additional bulk material (5) with at least three possibilities for inlets and outlets (4) for gases and liquids or preferably carbonated liquids via at least one sieve (3). The interior wall of the supply components (1) (11) (12) can also be used as a large surface area for carbonation

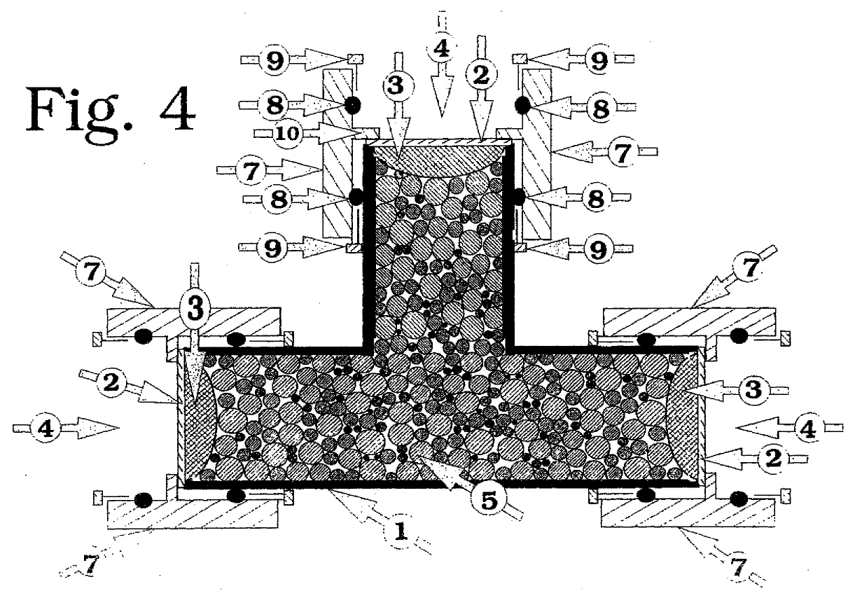

FIG. 4 shows: supply component (1) filled with preferably bulk material (5), carbonator for gases and equipped with at least preferably one sieve (3) retainer (2) and filled with preferably polycarbonate granulate bulk material (5) fill (5) with at least three inlet or outlet possibilities (4) for gases or liquids or gases in connection with liquids or exit possibilities (4) for preferably carbonated liquids. The surface of the exterior wall and the interior wall of the component (1) (11) (12) must be fabricated free of burs and can optionally be polished and should have a hygienic design. The fittings should be gas-tight. FIG. 4 also shows as an additional component (7) illustrated schematically with, for example, the component (9), retaining element O-ring (8) for gas-tightness and possibility for sealing, as well as a sieve retainer (10) integrated in the component (7). These so-called pluggable connectors are manufactured and distributed preferably by the company John Guest, and can be advantageously used with the invention as additional components (7) for the component (1). The component (1) can be manufactured as a turned part or as an injection molded part (not illustrated).

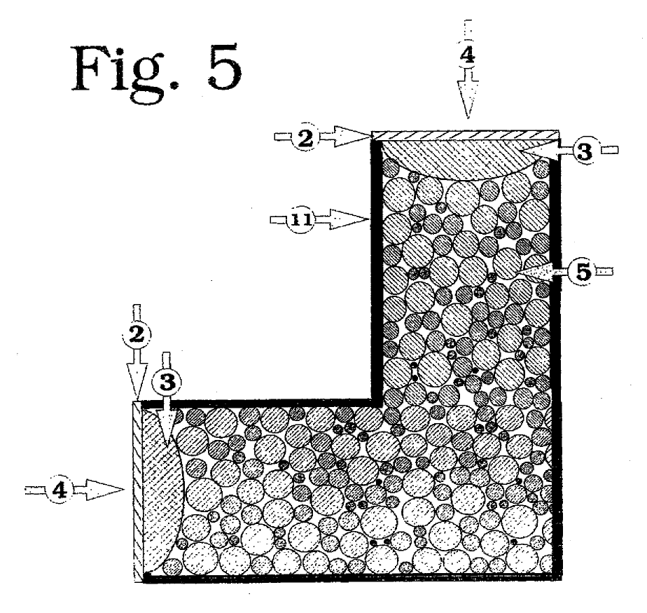

FIG. 5 shows: an angled supply component (11), filled with preferably bulk material (5), carbonator for gases and liquids with at least one sieve (3) retainer (2) and filled with preferably polycarbonate granulate bulk material fill (5) with two inlets or outlets (4) for gases in connection with liquids of the at least one outlet possibility (4) for carbonated or pre-impregnated liquid.

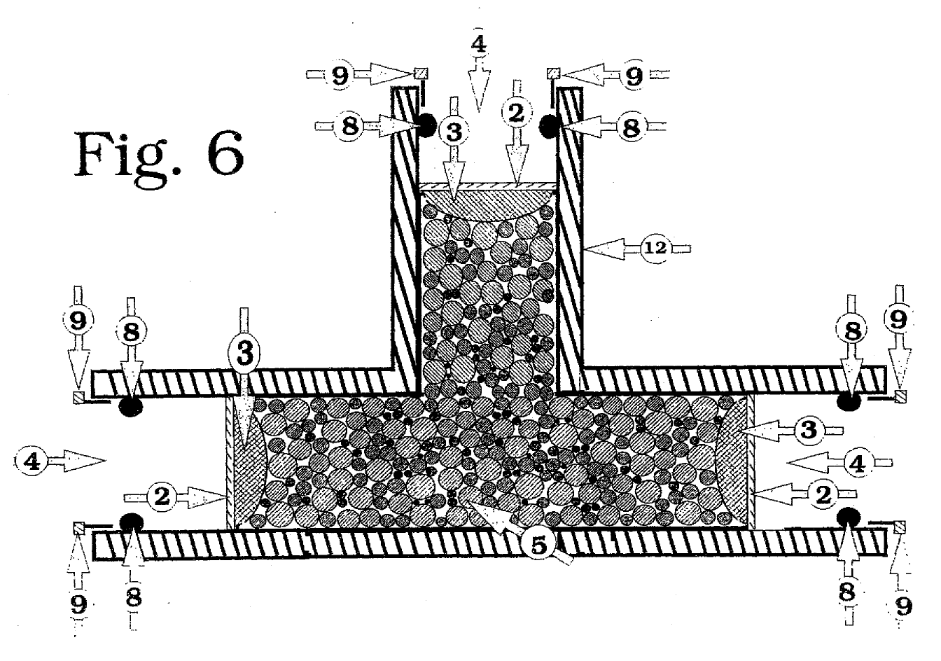

FIG. 6 shows: a schematic diagram of a T-shaped component (12) fabricated and suitable for use with connectors, such as for example the component (13), filled with preferably bulk material (5) which is secured by the retainer sieves (3) with integrated sieve retainer (2). The sieves (3) are simultaneously also secured by way of the sieve retainer (2) by the pluggable connector, such as for example the component (13) used for gases or for supplying liquid, so that the preferred bulk material (5) is cannot be flushed out through the sieves (3). The components, such as for example the O-ring (8) which is used, for example, for sealing the component (13), as well as the component (9) which is used as retainer element. The component (13) can be secured in addition by a retainer ring (not illustrated) of the type manufactured and distributed, for example, by the company John Guest. All connection should be gas-tight. The aforementioned components (9) (8) (3) (2) can be attached to the component (12) after being filled with the preferably solid matter (5).

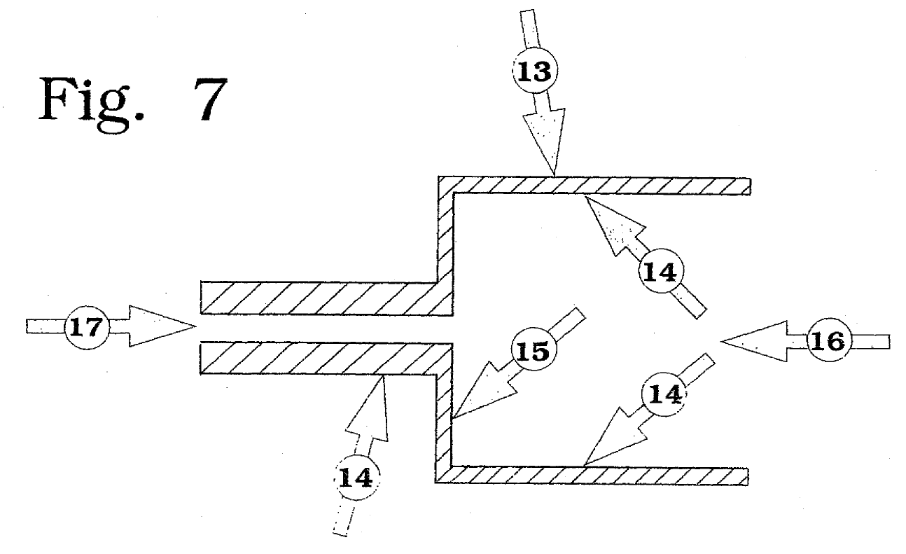

FIG. 7 shows: a schematic diagram of a component (13) which is manufactured so that on at least one side (16), at least one backflow preventer can be introduced gas-tight via the interior wall (14) and retainer bottom (15), and the gas or liquid flow or the gases in conjunction with the liquid can flow in through the opening (17) of the pluggable connector (14) as a common flow in the direction components (1) (11) (12), wherein the pluggable connector is configured that it can be inserted and secured, for example, in the component (12) gas-tight (not illustrated). The component (13) can be fabricated with shoulders, if such configuration is required in order to, for example, integrate at least one backflow preventer in the component (13). Both sides of the component (13) should be manufactured so that the gas and liquid supply and preferably the supply of carbonated liquid can be guaranteed (not illustrated) with additional pluggable connections (not illustrated). The opening should be dimensioned so that the inside diameter is smaller for a gas flow than for a liquid flow (not illustrated). In this way, a component (13) can be used for both media which flow into the components (1) (11) (12) separately or together when taken the opening (17) into consideration (not illustrated). The surfaces should be free of burs and gas-tight (not illustrated). The component can also be provided with an interior thread and an exterior thread (not illustrated).

Carbonation is provided without requiring an additional carbonator or inline carbonator, which is considered state-of-the-art. No components are known with a supply component which makes it possible to supply preferably tap water and CO₂ and to preferably carbonate inside the supply component (1) (11) (12)

preferably filled with bulk material (5), preferably at the same time the two media enter. This is made possible only by the present invention.

Another design of the invention was attained, in order to simplify for example the bulk material (5) and the assembly, by not entirely filling, for example, the component (1) (11) (12) with preferably solid matter (5), which is illustrated in exemplary form in FIG. 4.

The fact that the supply component (1) or (11) (12) is not entirely filled has no effect on the carbonation process, because when at least one dispensing location (not illustrated) is opened, the liquid and gas flow pushes the introduced preferably solid matter (5) against the retainer sieve (3), allowing for the misting end nebulizing process of the liquid to occur. The bulk material (5) will always adapt to the flow conditions of the two preferred media, if materials are employed for the preferably solid matter (5), which are lightweight and floatable, as for example granulate from polycarbonate (not illustrated).

1.-25. (canceled)

26. A supply component for gases and liquids, comprising:
a housing having an interior wall and a plurality of at least one inlet opening and an outlet opening,
a bulk material disposed inside the housing,
said bulk material nebulizing a liquid entering the housing through one of the inlet openings through contact with the bulk material or a surface of the interior wall and producing a misted liquid in a flow-through process and combining a gas entering the housing through another of the inlet openings with the nebulized liquid to produce a carbonated liquid which exits the housing through the outlet opening,
said supply component operating without an upstream or downstream carbonator.

27. The supply component of claim 26, wherein the bulk material comprises polycarbonate.

28. The supply component of claim 26, further comprising at least one sieve retaining the sieve bulk material inside the supply component and a sieve retainer for securing the sieve inside the housing.

29. The supply component of claim 26, wherein the at least one sieve retainer is secured to the interior wall of the housing.

30. The supply component of claim 29, wherein the at least one sieve retainer prevents the sieve from being flushed out.

31. The supply component of claim 29, wherein the housing is filled with the bulk material so that the bulk material covers the retainer sieve with bulk material.

32. The supply component of claim 26, wherein the liquid comprises water and the gas comprises CO₂.

33. The supply component of claim 26, wherein the housing is gas-tight.

34. The supply component of claim 32, wherein the bulk material nebulizes the liquid entering the inlet opening, or the liquid is cracked or sprayed, before combining with CO₂ before exiting through the outlet opening.

35. The supply component of claim 26, wherein the carbonated liquid is a carbonated refreshment drink.

36. The supply component of claim 28, wherein the at least one sieve is configured to produce an identical effect as the bulk material.

37. The supply component of claim 28, further comprising at least one gas-tight plug connector which includes the sieve retainer and is configured for use on an inlet or outlet opening.

38. The supply component of claim 28, wherein the inlet and outlet openings of the supply component are arranged at an angle with respect to one another.

39. The supply component of claim 26, wherein at least one the inlet or outlet openings is gas-tight and end sections of the housing having the inlet or outlet openings are configured to receive an external line, said external line operating as a sieve retainer.

40. The supply component of claim 26, wherein the supply component is gas-tight and further comprises at least one integrated backflow preventer and at least one through opening.

41. The supply component of claim 26, wherein supply component is configured as a gas-tight plug connector having a shoulder.

42. The supply component of claim 26, wherein the inlet or outlet openings comprise an interior thread or an exterior thread.

43. The supply component of claim 26, further comprising a cooler connected upstream of an inlet opening for cooling the liquid.

44. The supply component of claim 26, further comprising a cooler connected downstream of the outlet opening for cooling the carbonated liquid.

45. The supply component of claim 26, further comprising a displacement circulation pump or pressure booster pump disposed downstream of the outlet opening and supplying the carbonated liquid under in increased pressure to a dispensing location for the carbonated liquid.

46. The supply component of claim 45, wherein the displacement circulation pump or pressure booster pump is driven electrically or by a gas.

47. The supply component of claim 26, further comprising at least one regulator valve disposed upstream of an inlet opening for adjusting a flow pressure of the liquid to match flow pressure of the gas.

48. The supply component of claim 26, wherein the gas pressure is a CO₂ pressure which is mechanically adjustable.

49. The supply component of claim 26, further comprising at least one T-connector connected to the housing, with the T-connector forming a part of at least one carbonating water flow loop.

50. The supply component of claim 26, wherein the liquid is tap water mixed with a refreshment drink syrup to form a flavored liquid, and wherein the carbonated liquid is cooled before being supplied under increased pressure to a dispensing location in at least one recirculating line.

51. The supply component of claim 26, wherein the liquid is tap water mixed with a refreshment drink syrup to form a flavored liquid, and the flavored liquid is pre-cooled before entering the supply component.
